(19) United States
(12) Patent Application Publication
(10) Pub. No.: US 2015/0203654 A1
(43) Pub. Date: Jul. 23, 2015

(54) INORGANIC MODIFIER FOR HOT MIX ASPHALT FOR ROAD BUILDING AND METHOD OF MAKING SAME

(71) Applicant: JS3D Technology Company Limited, St. Lucia (TT)

(72) Inventor: Dolly NICHOLAS, Marabella (TT)

(73) Assignee: JS3D Technology Company Limited, St. Lucia (TT)

(21) Appl. No.: 14/159,575

(22) Filed: Jan. 21, 2014

(51) Int. Cl. C08K 3/34; C08L 95/00; C08K 3/36

(52) U.S. Cl. CPC C08K 3/346; C08K 3/36; C08L 95/00; C08L 2555/50; C08L 2555/22

(57) ABSTRACT

An organic modifier for hot mix asphalt containing one or more components of clay, feldspar, kaolinite or sand which absorb or adsorb oil. All or some of the components may be silane coupled. The modifier may include a clay which prevents the sedimentation of the asphalt to which it is added. The modifier is added to molten asphalt and stirred with the asphalt until homogeneous therewith.

The inorganic modifier is identified herein as JSIM.

### BACKGROUND OF THE INVENTION

1. Field of the Invention

The present invention relates to an inorganic modifier for hot asphaltic mixes for road paving and other applications, and to a method of making the synthetic modifier known as JSIM.

2. Description of the Background Art

At the present time, other than the present inorganic modifier, Trinidad Lake Asphalt (TLA) and JSSM (U.S. patent application Ser. No. 13/558558), are the only solid bituminous modifiers with inherent mineral matter which are classified as Superpave Grade - they are a mix of organic and inorganic. JSIM is only inorganic. Problems associated with TLA are documented in U.S. Pat. No. 6,558,462. Some of these problems are as follows:
1. Sedimentation;
2. Single source supply;
3. Costly process, requiring specialized equipment;
4. Expensive packaging material, which must be disposed of, thereby presenting potential environment issues;
5. Topping up of the drums or double handling.

The inorganic modifier of the present invention is not subject to any of the above-identified problems and possesses many advantages over TLA in performance, method of manufacture, handling, transportation and cost of production. At present, no inorganic modifier exists for hot asphaltic mixes which meets SHRP PG specifications. The inorganic modifier of the present invention, when added to refinery bitumen, produces modified bitumen which meets the respective SHRP PG specifications.

### BRIEF SUMMARY OF THE INVENTION

The modifier of the present invention is inorganic, exhibits no sedimentation, is not a single source material and thus can be manufactured anywhere, and does not require the use of specialized equipment for its manufacture, nor the use of continuous agitation during transport and storage. The modifier does not contain any polymers and thus is not subject to phase separation or similar problems. Also, the modifier causes a reduction of the poly aromatic hydrocarbons (PAH) in the base bitumen being modified.

The inorganic modifier of the present invention is one or more of the following: any clay, feldspar, kaolinite, sand or any inorganic matter which absorbs or adsorbs oil. It may also include one or more of any such clay, feldspar, kaolinite, sand or other inorganic matter which is silane coupled or coupled with a similar chemical or bonding agent. A suitable clay may be added to prevent sedimentation.

The inorganic modifier may be added to refinery bitumen in different ratios to produce road asphalt cements that have different Supersave PG Ratings. Each PG rating cement may have a different Penetration Grade or Viscosity Grade.

### DETAILED DESCRIPTION OF THE INVENTION

In the broadest aspect of the present invention, the inorganic modifier may be one or more of any clay, feldspar, kaolinite, sand or other suitable inorganic matter which absorbs or adsorbs oil.

Also, at least some of the modifier may be silane coupled or coupled with another suitable chemical or bonding agent such as a mercapto silane agent to reduce the PAH of the asphalt to which it is added. The modifier may also include a suitable clay, such as bentonite clay which keeps the inorganic fillers in suspension, to prevent sedimentation of the asphalt to which it is added.

Illustrative examples of compositions by weight of suitable inorganic modifiers in accordance with the present invention are as follows:

| Composition | Weight % |
|---|---|
| 1. 180/200 Ref. Bitumen | 77-90 |
| 2. Silica | 8-5 |
| 3. Kaolin | 12-4 |
| 4. Clay | 3-1 |

The inorganic modifier is added to hot bitumen or asphalt and then stirred with shear until the mixture is homogeneous. As illustrative examples, the asphalt may be 77-90% by weight and the inorganic modifier may be 10-23% by weight. Preferably, the particle size of the inorganic modifier is less than 10 microns.

In one specific example, the bitumen is 84.5% by weight and the modifier is 13% by weight of sand and 2.5% by weight of clay. The modifier was mixed with the hot bitumen at a temperature of about 325° F. and stirred with shear for about 2-3 minutes.

In another specific example, the bitumen is 84.5% by weight and the modifier is 4.10% by weight of sand and 11.4% by weight of kaolinite. The modifier was mixed with the hot bitumen at a temperature of about 325° F. and stirred with shear for about 2-3 minutes.

### Test Results

Tests of the PG rating and PAH level of refinery bitumen with and without an inorganic modifier (JSIM) having a composition of 84.4% of refinery bitumen and the inorganic modifier and being about 10-23% by weight of the refinery bitumen are as follows:

### PG Rating

| | |
|---|---|
| Refinery Bitumen 180-200 | PG 53.9-27.2 |
| Refinery Bitumen 180-200 + JSIM | PG 67.8-24.8 |
| Refinery Bitumen 60-70 | PG 64-16 |
| Refinery Bitumen 60-70 + JSIM | PG 75.0-20.0 |

The above modification was achieved with the use of the inorganic modifier (JSIM) only.

### PAH Reduction

The PAH level of the original bitumen and that of the modified asphalt cement are as follows:

| | ACTUAL (mg/kg) SAMPLE | | |
|---|---|---|---|
| | | 180/200 Virgin | LIMITS |
| PAH | 180/200 Virgin | with JSIM | (mg/kg) |
| Fluorene | 3.5 | 3.0 | 0.72-2.9 |
| 1-methylnaphthalene | 3.8 | 3.6 | 1.30-5.30 |
| 2-methylnaphthalene | 6.8 | 5.7 | 1.1-4.5 |
| Phenanthrene | 23 | 22 | 1.1-4.5 |

The above results show that there is reduction of the PAH level of the virgin refinery bitumen after being modified by the inorganic modifier (JSIM). The PAH test was done as per EPA 8270 (dilution level 2) with the level of all 18 PAHs being tested for.

| | ACTUAL (mg/kg) SAMPLE | | |
|---|---|---|---|
| | | 60/70 Virgin | LIMITS |
| PAH | 60/70 Virgin | with JSIM | (mg/kg) |
| 2-methylnaphthalene | 1.6 | NONE DETECTED | 1.1-4.5 |

The above results, once more, show that there is reduction of the PAH levels of the virgin refinery bitumen after being modified by the inorganic modifier (JSIM). The PAH test was done as per EPA 8270 (dilution level 2) with the levels of all 18 PAHs being tested for.

Sedimentation

A) The clay stated herein besides being a part of the modifier also prevents any sedimentation which may arise due to the added inorganic modifier/modifier mix Sedimentation profile tests show that there was no sedimentation.

B) Knowing that the clay aids in the non-sedimentation of the refinery bitumen with the inorganic modifier (JSIM) (which may or may not be siloxane bonded), the clay was used in a Trinidad Lake Asphalt (TLA) AC mix to determine if it would prevent sedimentation.

The sedimentation problems associated with TLA are well known and documented (U.S. Pat. No. 6,558,462).

In a drum of TLA, as sold, sedimentation occurs as shown below:

| SAMPLE | % ASH |
|---|---|
| Top | 35.46 |
| Next to Top | 36.96 |
| Next to Bottom | 37.78 |
| Bottom | 41.15 |

A blend of TLA 60/70 AC-blend of 37.5% TLA and 62.5% 180/200, by weight—was prepared. It was poured into a tube which was coated with a high temperature release agent, and placed in an oven for 3 hrs. at 160-170° C. The length of tube was 17cm (long)×2cm (wide). The sample was then cut into four portions and the ash obtained.

| SAMPLE | % ASH(ASTM D 2415) |
|---|---|
| Top | 8.59-9.23 |
| Next to Top | 10.22-10.06 |
| Next to Bottom | 10.35-10.55 |
| Bottom | 10.44-24.88 |

The complete test was repeated with conditions as stated above, this time with the addition of clay and the sample was left in the tube in the oven for 24 hrs. instead of 3 hrs.

| SAMPLE | % ASH(ASTM D 2415) |
|---|---|
| Top | 14.42, 12.93 |
| Next to Top | 13.82, 14.85 |
| Next to Bottom | 14.93, 13.82 |
| Bottom | 14.76, 17.25 |

As can be seen there was negligible sedimentation which can be removed by increasing the % of added clay.

The above test was once more repeated, but after being heated for 24 hours, the oven was shut down and the sample was left in the oven for 7 days. The oven was then turned on, and the sample reheated for an additional 24 hours.

| SAMPLE | % ASH(ASTM D 2415) |
|---|---|
| Top | 14.38, 10.96 |
| Next to Top | 15.15, 15.61 |
| Next to Bottom | 15.21, 14.88 |
| Bottom | 17.31, 16.92 |

Once more, there is negligible change to the sedimentation profile which can be removed by increasing the % of added clay.

It was determined, therefore, that the added clay solves the sedimentation problems associated with TLA asphaltic cements.

It will be readily seen, therefore, that the new and improved inorganic modifier of the present invention has many advantages, some of which are as follows:
1. JSIM Modifier and its asphaltic cements are non-sedimenting.
2. Modifier when mixed with refinery bitumen, in the ratios as stated, gives rise to an asphalt cement which fits into the SHRP specifications—PG 64-22. Other ratios produce different PG specifications.
3. Modifier is non-single source. Its components can be found in any part of the world with raw materials that are available internationally.
4. Specialized equipment is not needed when using the inorganic modifier for storage or transportation.
5. Exhibits both sol and gel behavior.
6. Meets SHRP modifier's specifications.
7. Addition of clay renders any asphalt cement mix of the modifier and refinery bitumen, non-sedimenting.
9. Simple process.
10. Cost effective.
12. Contains no polymers.
13. Requires no stirring during transport or storage.

The manufacture, handling, transportation and storage are major advantages of the inorganic modifier of the present invention when compared with other known hot mix modifiers presently in use.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An inorganic modifier for hot mix asphalt, comprising one or more components of clay, feldspar, kaolinite or sand which absorb or adsorb oil.

2. The modifier of claim 1 wherein the components reduce the PAH level of asphalt to which the modifier is added.

3. The modifier of claim 1 wherein some of the components are silane coupled to reduce the PAH level of asphalt to which the modifier is added.

4. The modifier of claim 1 wherein the components are silane coupled.

5. The modifier of claim 1 wherein the components include a clay that prevents sedimentation of asphalt to which the modifier is added.

6. The modifier of claim 5 wherein the clay is bentonite clay.

7. The modifier of claim 1 wherein the components are sand and clay.

8. The modifier of claim 1 wherein the components are sand and kaolinite.

9. The modifier of claim 1 wherein the particle size of the components is less than 10 microns.

10. A method of reducing the PAH level and sedimentation of refinery bitumen; comprising adding to the bitumen an inorganic modifier comprising one or more components of clay, feldspar, kaolinite or sand which absorb or adsorb oil.

11. The method of claim 10 wherein some of the components are silane coupled.

12. The method of claim 10 wherein the components are silane coupled.

13. The method of claim 10 wherein the components include a clay that prevents sedimentation of the bitumen.

14. The method of claim 10 wherein the components are sand and clay.

15. The method of claim 10 wherein the components are sand and kaolinite.

16. The method of claim 10 wherein the bitumen is 77-90% by weight and the inorganic modifier is 10-23% by weight.

17. The method of claim 10 wherein the inorganic modifier is added to molten bitumen and stirred with the bitumen until homogeneous therewith.

18. The method of claim 17 wherein the molten bitumen is at a temperature of about 325° F. and the modifier is stirred therewith for about 2-3 minutes.

19. The method of claim 10 wherein the particle size of the components is less than 10 microns.
